(19) United States
(12) Patent Application Publication
(10) Pub. No.: US 2018/0184097 A1
(43) Pub. Date: Jun. 28, 2018

(54) APPARATUS AND METHOD FOR VIDEO CODING, APPARATUS AND METHOD FOR VIDEO DECODING, AND NON-TRANSITORY COMPUTER-READABLE STORAGE MEDIUM

(71) Applicant: FUJITSU LIMITED, Kawasaki-shi (JP)

(72) Inventor: Kimihiko KAZUI, Kawasaki (JP)

(73) Assignee: FUJITSU LIMITED, Kawasaki-shi (JP)

(21) Appl. No.: 15/816,000

(22) Filed: Nov. 17, 2017

(30) Foreign Application Priority Data
Dec. 22, 2016 (JP) 2016-250012

(51) Int. Cl. H04N 19/186; H04N 19/176; H04N 19/124; H04N 19/117; H04N 19/44; H04N 19/96; H04N 19/70; H04N 19/86; H04N 19/107

(52) U.S. Cl. CPC H04N 19/186; H04N 19/176; H04N 19/124; H04N 19/117; H04N 19/107; H04N 19/96; H04N 19/70; H04N 19/86; H04N 19/44

(57) ABSTRACT

An apparatus executes a first process that includes palette coding a first pixel value in a block included in a video to generate a coding result, the first pixel value being registered in a palette of the block, quantizing a second pixel value in the block to generate a quantization result, the second pixel value being not registered in the palette, generating a first local decoding result from the coding result, and generating a second local decoding result from the quantization result, executes a second process that includes applying filter processing to the second local decoding result to generate a local decoded image of the block, the local decoded image including the first local decoding result and a result obtained by applying the filter processing to the second local decoding result, executes a third process that includes outputting a coded video including the coding result and the quantization result.

### CROSS-REFERENCE TO RELATED APPLICATION

This application is based upon and claims the benefit of priority of the prior Japanese Patent Application No. 2016-250012, filed on Dec. 22, 2016, the entire contents of which are incorporated herein by reference.

### FIELD

The embodiment discussed herein is related to an apparatus and method for video coding, an apparatus and method for video decoding, and a non-transitory computer-readable storage medium.

### BACKGROUND

The amount of moving image data is remarkably large in many cases. Therefore, when moving image data is transmitted from a transmitting device to a receiving device or when moving image data is stored in a storage device, compression coding of moving image data is performed.

As representative moving image coding standards, Moving Picture Experts Group phase 2 (MPEG-2), MPEG-4, and H.264 MPEG-4 Advanced Video Coding (MPEG-4 AVC/H.264) are known. These moving image coding standards have been developed by the International Organization for Standardization/International Electrotechnical Commission (ISO/IEC).

As a new moving image coding standard, High Efficiency Video Coding (HEVC), also known as MPEG-H/H.265, has been developed by the Joint Collaborative Team on Video Coding (JCTVC) (for example, see non-patent literature).

The moving image coding standards mentioned above adopt two coding schemes, inter-predictive coding and intra-predictive coding. The inter-predictive coding is a coding scheme that codes a picture to be coded by using information on a coded picture, and the intra-predictive coding is a coding scheme that codes a picture to be coded by using only information included in the picture to be coded.

With the recent progress in information technology (M, there has emerged a trend of applying moving image coding standards to screen content images like those displayed on a desktop screen of a personal computer (PC), in addition to natural images captured by various cameras. For example, wireless display, desktop virtualization (virtual display infrastructure (VDI)), and the like belong to this trend.

By using wireless display, a displayed video on a PC or a video game console may be wirelessly transmitted to a flat panel display. By using VDI, the user screen of a virtual operating system (virtual OS) may be transmitted over Internet protocol (IP) to a client terminal.

A screen content image has features different from those of a natural image. Specifically, one of the features is that there is a very small range of variations of the pixel values in a block. For example, for a 24-bit video, as many as about 20 colors among 16,770,000 colors are used on a text editing screen.

In the third edition of the HEVC standard internationally standardized in 2013, techniques for compression coding a screen content image with high efficiency are introduced. One of the techniques is palette coding.

FIG. 1 illustrates an example of palette coding in an apparatus for video coding (hereinafter also referred to as a video coding apparatus). An image 101 of a block in FIG. 1 includes 64 (8×8) pixels, and a palette 103 for coding this block is generated from each pixel value of the image 101. Each entry of the palette 103 corresponds to a color included in the image 101 and includes an index and a pixel value. The index is a code representing the color, and the pixel value is a pixel value representing the color. In this example, (R, G, B) is used as a pixel value. The palette 103 is sometimes called a palette table.

Replacing each pixel value of the image 101 with an index by using the palette 103 generates an index map 102, and coding the index map 102 and the palette 103 generates a coding result of the image 101. When there is a small range of variations of pixel values in a block, the amount of information of the index map 102 is small and therefore the coding efficiency improves.

The values of R, G, and B are each represented in 8 bits, and therefore the amount of information per pixel of the image 101 is 8×3=24 bits and the amount of information of the entire image 101 is 24×64=1536 bits. In contrast, each index is represented in 3 bits, and therefore the amount of information of the index map 102 is 3×64=192 bits.

Palette coding is available for both modes, lossless coding and lossy coding. In the mode of lossy coding, escape coding is used. In escape coding, when more kinds of pixel values are included in a block than the kinds of pixel values registered in a palette, pixel values that are not registered in the palette are directly quantized and coded.

In the case of the image 101 in FIG. 1, the pixel value of a pixel 111 at the upper right is escape coded, and an index “5” indicating escape coding is recorded at the corresponding position in the index map 102. An apparatus for video decoding (hereinafter also referred to as a video decoding apparatus) decodes bit streams generated by the video coding apparatus. When the index of a pixel indicates escape coding, the video decoding apparatus inverse quantizes quantized pixel values included in the bit stream to restore the original pixel values.

The amount of information of code generated by palette coding is proportional to the palette size, and therefore two parameters, the palette size and the quantization scale of escape coding, are changed when rate control is performed over bit streams.

An adaptive filter that applies filter processing to a decoded image is also known.

Examples of the related art include Japanese Laid-open Patent Publication No. 2016-76924, International Publication Pamphlet No. WO 2015/163046, International Publication Pamphlet No. WO 2012/081706, Japanese National Publication of International Patent Application No. 2015-519853, and non-patent literature (“Text of ISO/IEC FDIS 23008-2:201× High Efficiency Video Coding [3rd ed.]”, ISO/IEC JTC1/SC29/WG11/N16046, February 2016).

### SUMMARY

According to an aspect of the invention, an apparatus for video coding includes: a memory; and a processor coupled to the memory and configured to execute a palette coding process that includes palette coding a first pixel value out of a plurality of pixel values in a block to be coded included in a video to be coded to generate a coding result of the first pixel value, the first pixel value being registered in a palette of the block to be coded, quantizing a second pixel value out of the plurality of pixel values to generate a quantization result of the second pixel value, the second pixel value being not registered in the palette, generating a first local decoding result from the coding result of the first pixel value, and generating a second local decoding result from the quantization result of the second pixel value, execute a local decoded image generation process that includes applying filter processing to the second local decoding result to generate and store a local decoded image of the block to be coded into the memory in preparation for a predictive coding, the local decoded image including the first local decoding result and a result obtained by applying the filter processing to the second local decoding result, execute an output process that includes outputting a coded video including the coding result of the first pixel value and the quantization result of the second pixel value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating palette coding;

FIG. 2A and FIG. 2B are a diagram illustrating filter processing by a sample adaptive offset (SAO) filter;

FIG. 3 is a diagram illustrating a functional configuration of a video coding apparatus;

FIG. 4 is a flowchart of a video coding process;

FIG. 5 is a diagram illustrating a functional configuration of a video decoding apparatus;

FIG. 6 is a flowchart of a video decoding process;

FIG. 7 is a diagram illustrating a functional configuration of a specific example of a video coding apparatus;

FIG. 8 is a diagram illustrating a functional configuration of an SAO filter unit of a video coding apparatus;

FIG. 9 is a flowchart illustrating a specific example of a video coding process;

FIG. 10 is a diagram illustrating a functional configuration of a specific example of a video decoding apparatus;

FIG. 11 is a diagram illustrating a functional configuration of an SAO filter unit of a video decoding apparatus;

FIG. 12 is a flowchart illustrating a specific example of a video decoding process;

FIG. 13 is a diagram illustrating syntax of a coding tree unit (CTU);

FIG. 14 is a diagram illustrating syntax of coding quadtree;

FIG. 15 is a diagram illustrating syntax of a coding unit (CU); and

FIG. 16 is a diagram illustrating a configuration of an information processing apparatus.

### DESCRIPTION OF EMBODIMENT

In related-art palette coding, filter processing is sometimes applied to a local decoded image in order to reduce degradation in image quality due to quantization in escape coding. However, if filter processing is applied to a pixel that is not escape coded, the image quality of the pixel is degraded by unnecessary filtering.

Such a problem occurs not only in palette coding for a screen content image but also in palette coding for another image with a small range of variations of pixel values.

According to an aspect of the present disclosure, there is provided a technique to suppress degradation in image quality caused by filter processing when palette coding is performed in video coding.

Hereinafter, an embodiment will be described in detail with reference to the accompanying drawings.

First, block partitioning in HEVC will be described. In HEVC, four types of blocks called a coding tree unit (CTU), a coding unit (CU), a prediction unit (PU), and a transform unit (TU) are prepared. The CTU is a block that is a root node when the block partitioning is assumed as a tree structure, and corresponds to the maximum possible block size of a CU.

The CU is a block that is a leaf node of the tree structure and is a unit by which a prediction mode such as inter prediction or intra prediction is determined. The PU is one of blocks into which a CU is further divided, and is a unit by which an optimal prediction measure is selected from among predictive modes determined for the CU. For example, a prediction direction is selected for intra prediction, and a motion vector is selected for inter prediction. The TU is one of blocks into which a CU is further divided, and is a unit by which an orthogonal transform is performed. Palette coding is performed on a CU-by-CU basis, and a palette used for coding is generated for each CU.

In the HEVC standard, in addition to a deblocking filter, a sample adaptive offset (SAO) filter is employed as post-filtering for reducing degradation caused by quantization of an orthogonal transform coefficient. The deblocking filter has been employed since the AVC standard.

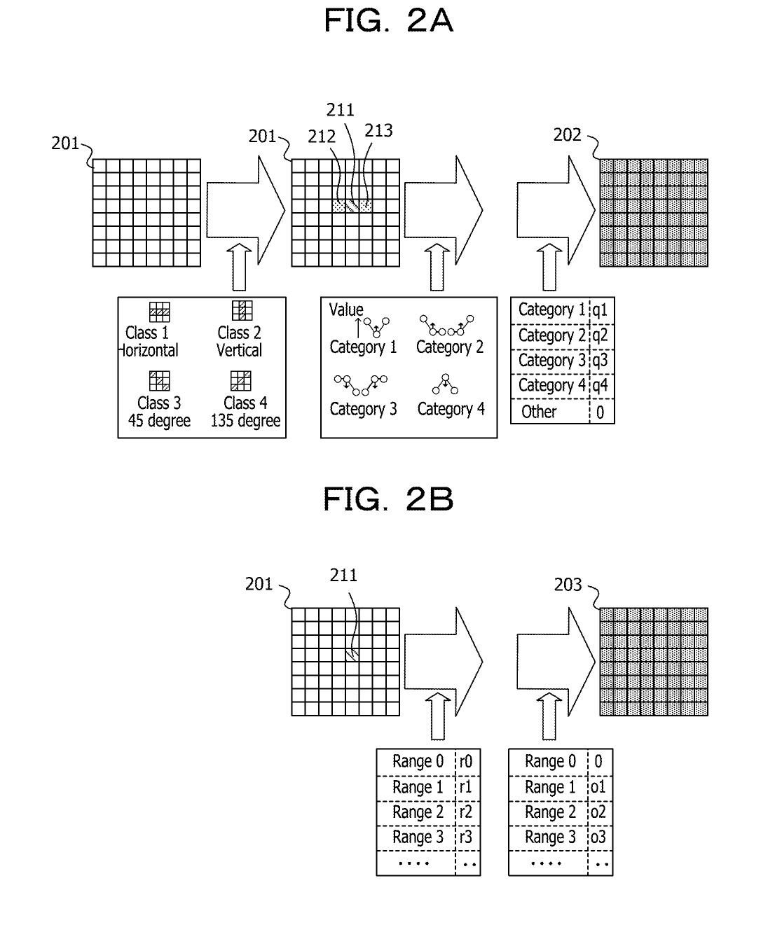

FIG. 2 (i.e., FIG. 2A and FIG. 2B) illustrates an example of filter processing by an SAO filter. Filter processing by the SAO filter is applied to a result obtained by applying filter processing to a decoded image by using a deblocking filter.

Filter processing by the SAO filter has two filter modes, edge offset and band offset, either of which may be selected on a CU-by-CU basis. Filter processing of the edge offset mode is processing for correcting distortion of an edge in a CU, and filter processing of the band offset mode is processing for correcting distortion of gray scale in a CU.

In FIG. 2A, an example of edge offset is illustrated. In filter processing of the edge offset mode, an offset value corresponding to the shape of a variation in pixel value in an edge direction selected on a CU-by-CU basis is added to the pixel value of each pixel in a CU.

In this example, any one edge direction among Class 1 (horizontal direction), Class 2 (vertical direction), Class 3 (45-degree direction), and Class 4 (135-degree direction) is selected for a CU to be processed 201. Next, the pixel value of each pixel in the CU to be processed 201 is compared with the pixel values of two pixels adjacent to the pixel, so that a category indicating the shape of a variation in pixel value in the edge direction is calculated. At this point, the two adjacent pixels are selected in accordance with the edge direction.

For example, when Class 1 is selected, a pixel 212 and a pixel 213, which are horizontally adjacent to a pixel to be processed 211, are selected as reference pixels. It is then determined which of the shapes of Category 1 to Category 4 and other shapes is the shape to which the relative relationship among the pixel values of the pixel to be processed 211, the reference pixel 212, and the reference pixel 213 corresponds.

Next, an offset value corresponding to the determined category is added to the pixel value of each pixel in the CU to be processed 201, so that a CU 202 after being subjected to filter processing is generated. The offset values corresponding to Category 1 to Category 4 are q1 to q4, respectively, and the offset values corresponding to other shapes are zero. For example, when the category of the pixel to be processed 211 is Category 3, the offset value, q3, is added to the pixel value, p, of the pixel to be processed 211 and thereby the pixel value is changed to p+q3.

In FIG. 2B, an example of band offset is illustrated. In filter processing of the band offset mode, an offset value corresponding to the range for the pixel value of each pixel in a CU is added to the pixel value. Each range may be defined by the upper and lower limits of a pixel value.

In this example, it is determined which range among Range 0 (r0), Range 1 (r1), Range 2 (r2), Range 3 (r3), and the like is the range to which the pixel value of each pixel in the CU to be processed 201 belongs.

Next, an offset value corresponding to the determined range is added to the pixel value of each pixel in the CU to be processed 201, so that a CU 203 after being subjected to filter processing is generated. The offset value corresponding to Range 0 is zero, and the offset values corresponding to Range 1 to Range 3 are o1 to o3, respectively. For example, when the pixel value p of the pixel to be processed 211 belongs to Range 2, the offset value o2 is added to the pixel value p and thereby the pixel value is changed to p+o2.

In lossy coding of a screen content image, using palette coding and the SAO filter together makes it possible to improve coding efficiency. However, when the SAO filter of the HEVC standard is applied, undesired degradation in image quality occurs in some cases.

In palette coding, when escape coding is used as lossy coding, degradation in image quality due to quantization is added only to escape coded pixels. In contrast, degradation due to quantization does not occur in the pixel values of pixels that are not escape coded. Hereinafter, in some cases, a pixel that is escape coded is referred to as an escape coded pixel, and a pixel that is not escape coded is referred to as a non-escape coded pixel.

The SAO filter is filter processing for reducing degradation due to quantization and is applied to all of the pixels in a CU. In this case, the SAO filter is applied even to non-escape coded pixels, where degradation due to quantization does not occur. Therefore, unnecessary filter processing degrades the image quality of the non-escape coded pixels, decreasing coding efficiency (compression efficiency).

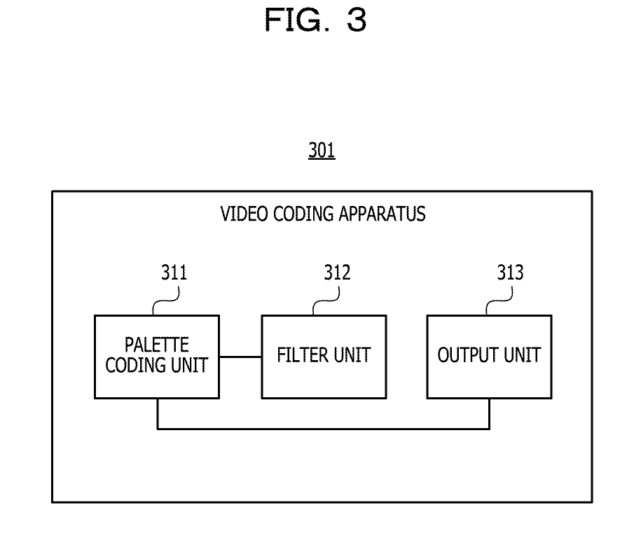

FIG. 3 illustrates an example of a functional configuration of a video coding apparatus of an embodiment. A video coding apparatus 301 in FIG. 3 includes a palette coding unit 311, a filter unit 312, and an output unit 313.

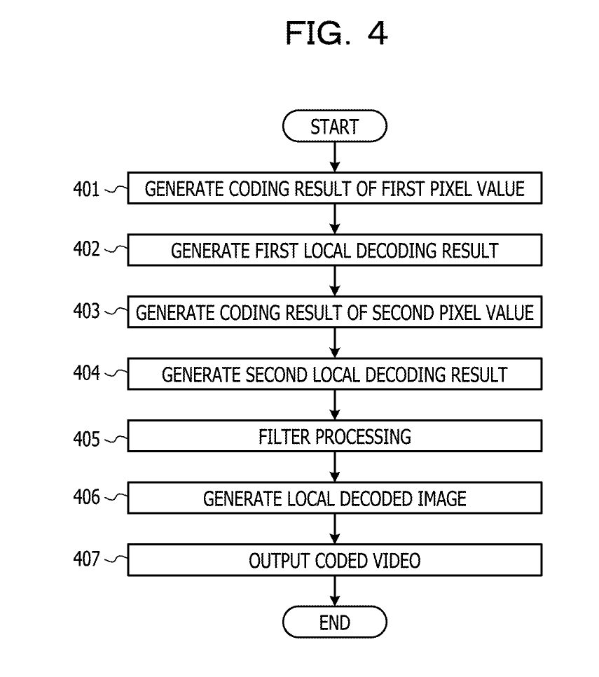

FIG. 4 is a flowchart illustrating an example of a video coding process executed by the video coding apparatus 301 in FIG. 3. First, the palette coding unit 311 codes, out of a plurality of pixel values in a block to be coded included in a video to be coded, a first pixel value registered in a palette of the block to be coded, by using a palette, to generate a coding result of the first pixel value (step 401). Then, the palette coding unit 311 generates a first local decoding result from the coding result of the first pixel value (step 402).

Next, the palette coding unit 311 quantizes a second pixel value that is not registered in the palette to generate a quantization result of the second pixel value (step 403) and generates a second local decoding result from the quantization result of the second pixel value (step 404).

Next, the filter unit 312 applies filter processing to the second local decoding result (step 405) and generates a local decoded image of the block to be coded including the first local decoding result and a result obtained by applying filter processing to the second local decoding result (step 406). In the step 406, the filter unit 312 may store the local decoded image into a memory in preparation for a predictive coding. Then, the output unit 313 outputs a coded video including the coding result of the first pixel value and the quantization result of the second pixel value (step 407).

According to the video coding apparatus 301 configured in such a manner, when palette coding is performed in video coding, degradation in image quality due to filter processing may be suppressed.

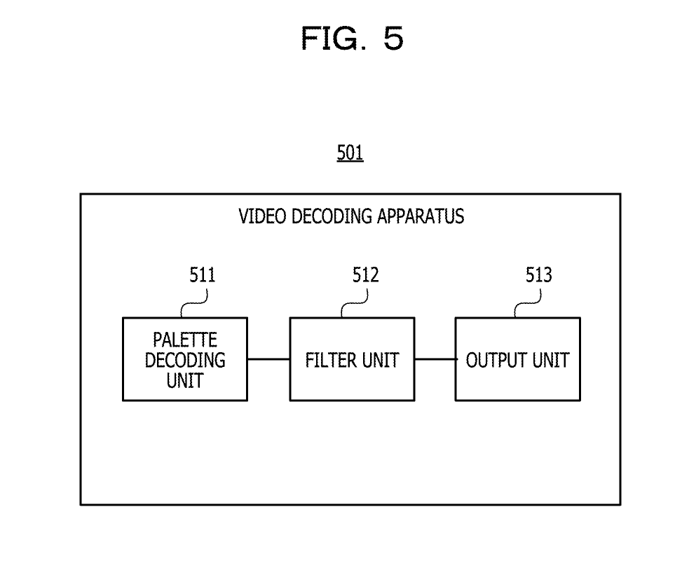

FIG. 5 illustrates an example of a functional configuration of a video decoding apparatus of an embodiment. A video decoding apparatus 501 in FIG. 5 includes a palette decoding unit 511, a filter unit 512, and an output unit 513.

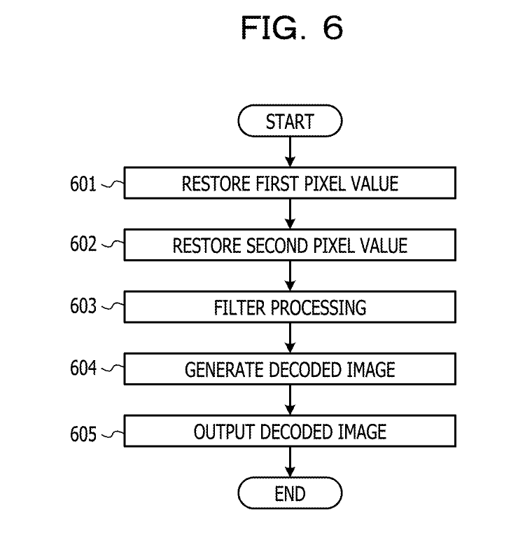

FIG. 6 is a flowchart illustrating an example of a video decoding process executed by the video decoding apparatus 501 in FIG. 5. First, the palette decoding unit 511 decodes a coding result of a first pixel in a block to be decoded included in a video to be decoded, by using a palette of the block to be decoded, to restore a first pixel value of the first pixel (step 601). Next, the palette decoding unit 511 inverse quantizes a quantization result of a second pixel in the block to be decoded to restore a second pixel value of the second pixel (step 602).

Next, the filter unit 512 applies filter processing to the second pixel value (step 603) and generates a decoded image of the block to be decoded including the first pixel value and a result obtained by applying filter processing to the second pixel value (step 604). Then, the output unit 513 outputs a decoded video including the decoded image of the block to be decoded (step 605).

According to the video decoding apparatus 501 configured in such a manner, when palette coding is performed in video coding, degradation in image quality due to filter processing may be suppressed.

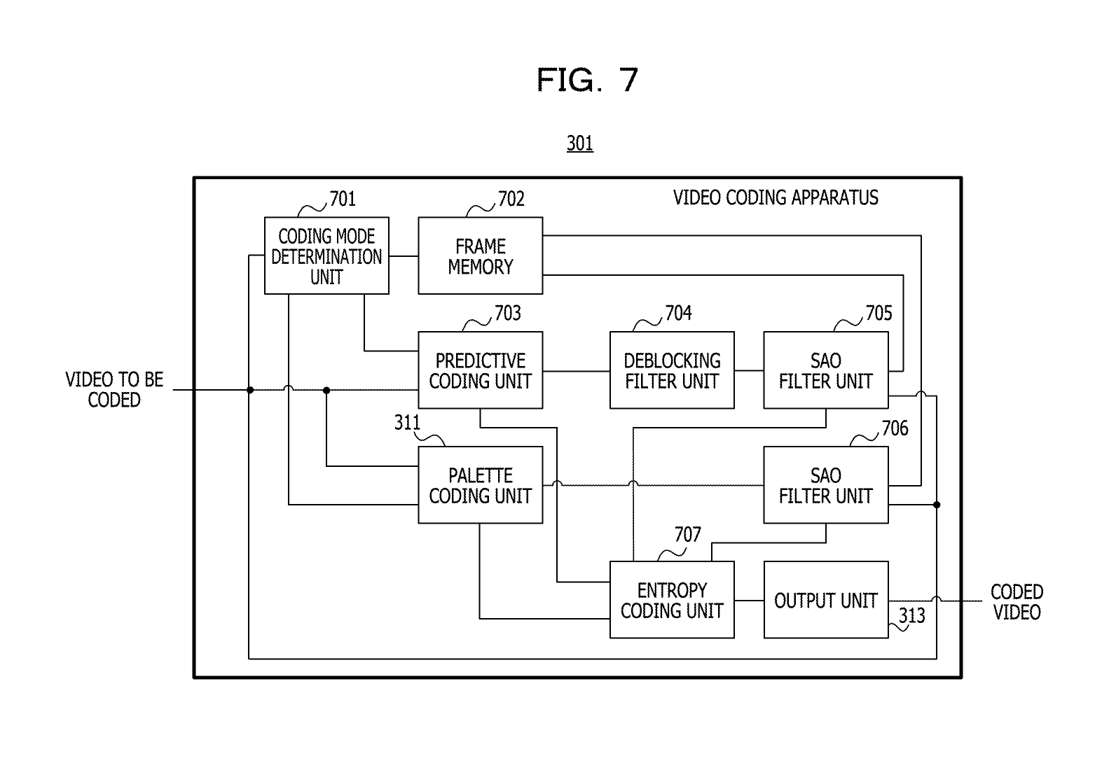

FIG. 7 illustrates a specific example of the video coding apparatus 301 in FIG. 3. The video coding apparatus 301 in FIG. 7 includes the palette coding unit 311, the output unit 313, a coding mode determination unit 701, a frame memory 702, a predictive coding unit 703, a deblocking filter unit 704, and an SAO filter unit 705. The video coding apparatus 301 further includes an SAO filter unit 706 and an entropy coding unit 707. The SAO filter unit 706 corresponds to the filter unit 312 in FIG. 3.

The video coding apparatus 301, for example, may be implemented as a hardware circuit. In this case, components of the video coding apparatus 301 may be implemented as individual circuits or may be implemented as one integrated circuit.

The video coding apparatus 301 codes a video to be coded that has been input, and outputs bit streams of the coded video. The video to be coded includes a plurality of images captured at a plurality of times, respectively. Each image may be a color image or may be a monochrome image. When the image is a color image, the pixel value may be in an RGB format or may be in a YUV format. Each image is sometimes called a frame or a picture.

Each image included in the video to be coded is divided on a block-by-block basis, and each block is input as a block to be coded to the predictive coding unit 703 and the palette coding unit 311. In the case of HEVC, each block corresponds to a CTU or a CU.

The frame memory 702 is a storage unit that stores therein a local decoded image of each block, and outputs the local decoded image as a reference image of a block to be coded to the coding mode determination unit 701. The coding mode determination unit 701 determines a block size and a coding mode of each block by using the video to be coded and the reference image output from the frame memory 702. The coding mode of each block is any of intra-predictive coding, inter-predictive coding, and palette coding.

When the intra-predictive coding or the inter-predictive coding is selected as the coding mode of a block, the coding mode determination unit 701 outputs a block size, a coding mode, and a predicted pixel value to the predictive coding unit 703. The predicted pixel value is generated from a local decoded pixel value of an adjacent block or a local decoded pixel value of a reference image. When palette coding is selected as the coding mode of a block, the coding mode determination unit 701 outputs a block size and a coding mode to the palette coding unit 311.

The predictive coding unit 703 performs predictive coding of a block to be coded when the coding mode is intra-predictive coding or inter-predictive coding. At this point, the predictive coding unit 703 subtracts a predictive pixel value from the pixel value of each pixel in the block to be coded to generate a prediction error. Then, the predictive coding unit 703 orthogonal transforms the prediction error and then quantizes it to generate coefficient information. As the orthogonal transform, for example, a discrete cosine transform, a discrete wavelet transform, or the like is used.

Next, the predictive coding unit 703 outputs predictive coding parameters, such as a coding mode (prediction mode), and coefficient information to the entropy coding unit 707. The predictive coding parameters further include information indicating a prediction direction when the coding mode is intra-predictive coding, and the predictive coding parameters further include information indicating a motion vector when the coding mode is inter-predictive coding.

In addition, the predictive coding unit 703 inverse quantizes the coefficient information and then inverse orthogonal transforms it to generate a reconfigured prediction error, and adds the reconfigured prediction error and the predicted pixel value together to generate a local decoded pixel value before post-filtering. The predictive coding unit 703 then outputs the local decoded pixel value before post-filtering to the deblocking filter unit 704.

The deblocking filter unit 704 applies deblocking filter processing to the local decoded pixel value before post-filtering and outputs a result of the deblocking filter processing to the SAO filter unit 705.

The SAO filter unit 705 applies SAO filter processing to the result of deblocking filter processing. As the SAO filter processing, for example, SAO filter processing defined in the HEVC standard may be used.

First, the SAO filter unit 705 selects any filter mode among band offset, edge offset, and non-application of a filter. Then, the SAO filter unit 705 calculates an offset value corresponding to each range when the filter mode is band offset, and calculates an offset value corresponding to each category when the filter mode is edge offset. These offset values are determined so as to minimize the difference between a pixel value before coding and a pixel value obtained after SAO filter processing has been applied.

Next, the SAO filter unit 705 adds an offset value in the selected filter mode to the pixel value of each pixel in the block to generate a local decoded pixel value after post-filtering, and outputs the local decoded pixel value to the frame memory 702. The SAO filter unit 705 also outputs SAO parameters including the filter mode, the offset value, and the like to the entropy coding unit 707. In the case of HEVC, the SAO parameters are determined on a per-largest coding unit (LCU) basis.

The frame memory 702 stores therein the local decoded pixel value of each pixel in the block to be coded, as a local decoded image. This local decoded image is used as a reference image for the subsequent images.

The palette coding unit 311 performs palette coding of a block to be coded when the coding mode is palette coding. First, the palette coding unit 311 generates a palette of a block to be coded from the pixel value of each pixel in the block to be coded.

Next, by reference to the generated palette, the palette coding unit 311 replaces the pixel value with the corresponding index in the palette to generate a coding result of the pixel if the pixel value (which may be referred to as “a first pixel value”) of a pixel in the block to be coded is registered in the palette. Otherwise, if the pixel value (which may be referred to as “a second pixel value”) of a pixel in the block to be coded is not registered in the palette, the palette coding unit 311 replaces the pixel value with an index indicating escape coding and quantizes the pixel value to generate a quantization result.

Next, the palette coding unit 311 outputs the palette for the block to be coded, the index of each pixel, and the quantization results of escape coded pixels (which may be referred to as “a quantization result of the second pixel value”) to the entropy coding unit 707. The palette coding unit 311 then outputs palette parameters including the size of the palette, the quantization scale for escape coding, and the like to the entropy coding unit 707.

The palette coding unit 311 also generates a local decoded pixel value before post-filtering of each pixel and outputs the index and the local decoded pixel value of each pixel to the SAO filter unit 706.

For the case of a non-escape coded pixel, the palette coding unit 311 uses a pixel value corresponding to the index of the coding result (which may be referred to as “the coding result of the first pixel value”) in the palette as a local decoded pixel value (which may be referred to as “a first local decoding result”) before post-filtering. In this case, the local decoded pixel value matches the pixel value before coding. In contrast, for the case of an escape coded pixel, the palette coding unit 311 inverse quantizes a quantization result to generate a local decoded pixel value (which may be referred to as “a second local decoding result”) before post-filtering. In this case, the local decoded pixel value does not have to match the pixel value before coding.

The SAO filter unit 706 applies SAO filter processing to a local decoded pixel value before post-filtering. First, the SAO filter unit 706 selects any filter mode among band offset, edge offset, and non-application of a filter by using only the local decoded pixel value of an escape coded pixel in a block to be coded.

The SAO filter unit 706 then calculates an offset value corresponding to each range when the filter mode is band offset, and calculates an offset value corresponding to each category when the filter mode is edge offset. These offset values are determined so as to minimize the difference between the pixel value before coding of an escape coded pixel and the pixel value obtained after SAO filter processing has been applied.

Next, the SAO filter unit 706 adds an offset value in the selected filter mode to the local decoded pixel value (which may be referred to as “the second local decoding result”) of each escape coded pixel in the block to generate a local decoded pixel value after post-filtering, and outputs the local decoded pixel value after post-filtering to the frame memory 702. The SAO filter unit 706 also outputs the local decoded pixel value (which may be referred to as “the first local decoding result”) of each non-escape coded pixel in the block, as a local decoded pixel value after post-filtering, to the frame memory 702.

The SAO filter unit 706 outputs SAO parameters including a filter mode, offset values, and the like to the entropy coding unit 707. In the case of HEVC, the SAO parameters are determined on a per-LCU basis.

The entropy coding unit 707 performs entropy coding for information output from the predictive coding unit 703, the palette coding unit 311, the SAO filter unit 705, and the SAO filter unit 706 to generate bit streams of a coded video.

The information to be entropy-coded includes coding parameters on image-by-image basis, such as a picture type, SAO parameters for each LCU in an image, and a coding mode of each block. The information to be entropy-coded further includes predictive coding parameters, coefficient information, palette coding parameters, a palette, indices, and the quantization results of escape coded pixels. In entropy coding, a variable-length code is assigned in accordance with the frequency of appearance of each symbol in information.

The output unit 313 outputs bit streams of a coded video generated by the entropy coding unit 707 to the video decoding apparatus 501.

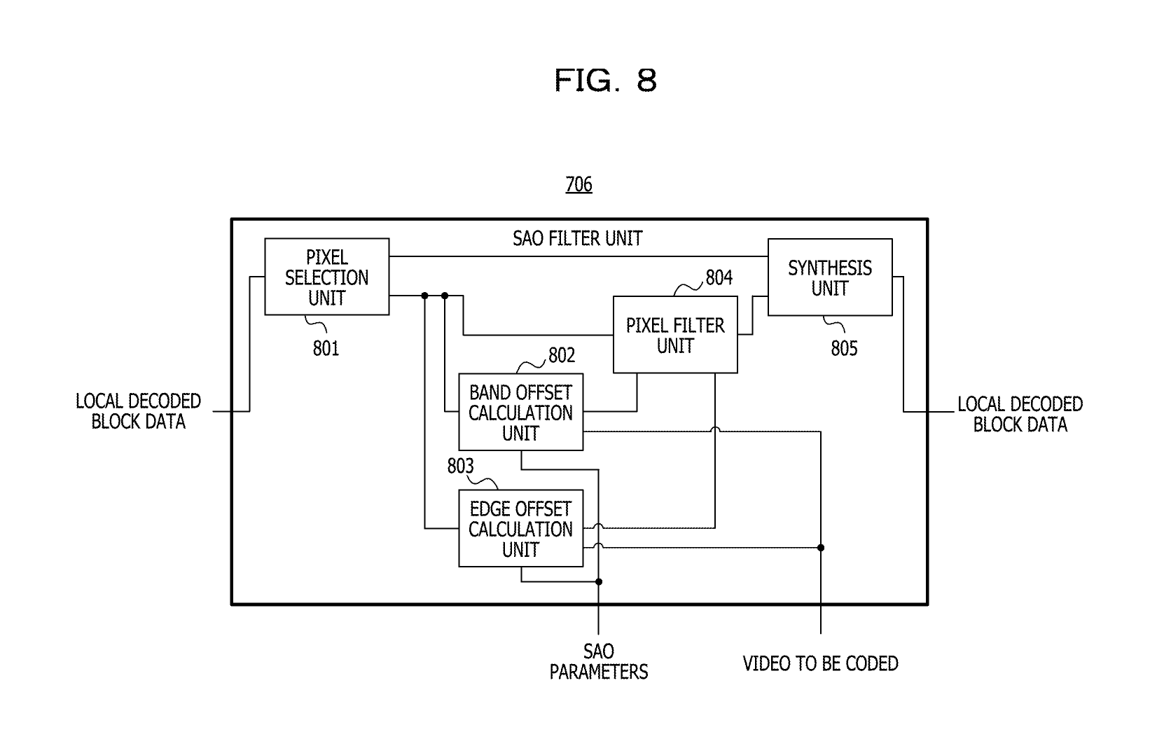

FIG. 8 illustrates an example of a functional configuration of the SAO filter unit 706 in FIG. 7. The SAO filter unit 706 in FIG. 8 includes a pixel selection unit 801, a band offset calculation unit 802, an edge offset calculation unit 803, a pixel filter unit 804, and a synthesis unit 805. Local decoded block data in which the local decoded pixel values of escape coded pixels and non-escape coded pixels exist in a mixed manner are input to the pixel selection unit 801.

The pixel selection unit 801 refers to the index of each pixel in the block and, if the index indicates an escape coded pixel, the pixel selection unit 801 outputs the local decoded pixel value of the pixel to the band offset calculation unit 802, the edge offset calculation unit 803, and the pixel filter unit 804. In contrast, if the index indicates a non-escape coded pixel, the pixel selection unit 801 outputs the local decoded pixel value of the pixel to the synthesis unit 805.

The band offset calculation unit 802 calculates an offset value in the filter mode of band offset and the coding cost by using the local decoded pixel value of an escape coded pixel and the pixel value of the original image included in a video to be coded. As the coding cost, for example, the amount of coded data of the offset value of band offset and a difference between the local decoded pixel value and the pixel value of the original image may be used. The band offset calculation unit 802 then outputs a list of offset values for a plurality of escape coded pixels in the block and the coding cost to the pixel filter unit 804.

The band offset calculation unit 802 also outputs the SAO parameters including the filter mode of band offset and a list of offset values to the entropy coding unit 707.

The edge offset calculation unit 803 calculates an offset value and the coding cost in the filter mode of edge offset by using a local decoded pixel value of an escape coded pixel and the pixel value of the original image included in a video to be coded. As the coding cost, for example, the amount of coded data of the offset value of edge offset and a difference between the local decoded pixel value and the pixel value of the original image may be used. The edge offset calculation unit 803 then outputs a list of offset values for a plurality of escape coded pixels in a block and the coding cost to the pixel filter unit 804.

The edge offset calculation unit 803 also outputs SAO parameters including the filter mode of edge offset and a list of offset values to the entropy coding unit 707.

The pixel filter unit 804 compares the coding costs in two filter modes, band offset and edge offset, to each other and selects a filter mode with a smaller coding cost. Then, using the list of offset values of the selected filter mode, the pixel filter unit 804 adds the offset value of an escape coded pixel to the local decoded pixel value of the escape coded pixel, and outputs a local decoded pixel value, which is a result of the addition, to the synthesis unit 805.

The synthesis unit 805 outputs local decoded pixel values output from the pixel selection unit 801 for non-escape coded pixels in the block, and outputs local decoded pixel values output from the pixel filter unit 804 for escape coded pixels. Thus, local decoded block data in which the local decoded pixel values to which filter processing has been applied and the local decoded pixel values to which filter processing is not applied exist in a mixed manner is output.

According to the video coding apparatus 301 in FIG. 7, SAO filter processing is applied only to escape coded pixels among pixels in a palette coded block, and SAO filter processing is not applied to non-escape coded pixels. Accordingly, the image quality of non-escape coded pixels where degradation due to quantization has not occurred is not impaired, and therefore a local decoded image of high quality may be generated. Furthermore, predictive coding of the subsequent images is performed by using a local decoded image of high quality, and thus a video may be coded with high efficiency.

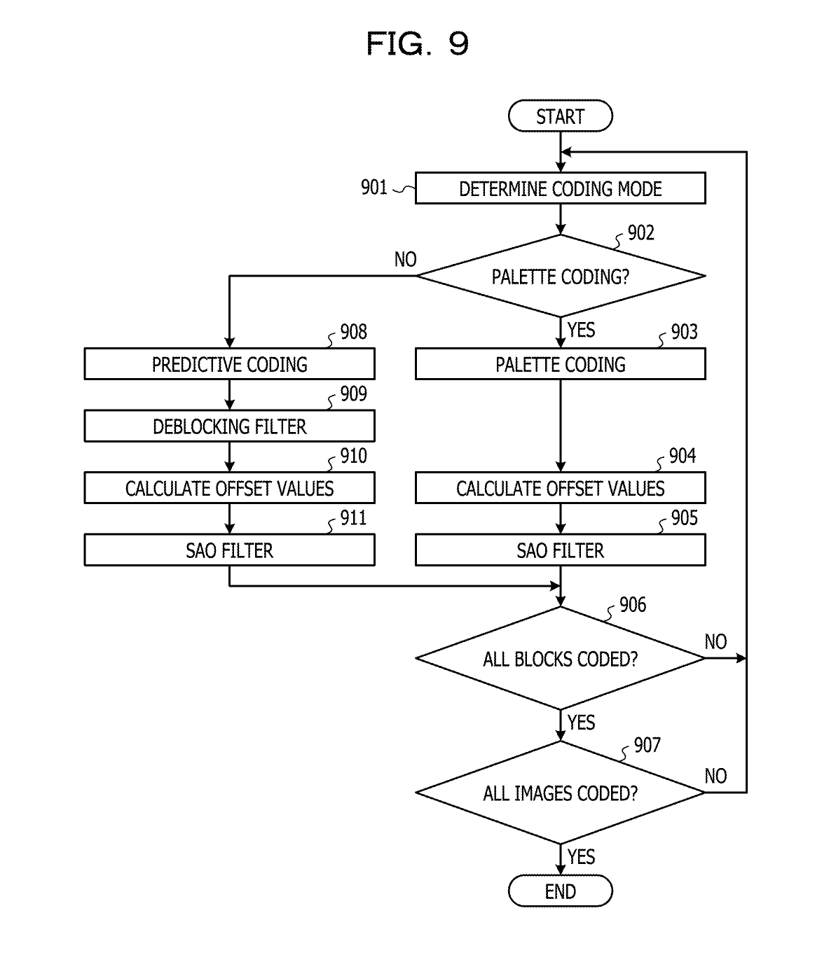

FIG. 9 is a flowchart illustrating a specific example of a video coding process executed by the video coding apparatus 301 in FIG. 7. First, a coding mode determination unit 701 determines the block size of a block to be coded in an image included in a video to be coded and the coding mode (step 901). Then, the predictive coding unit 703 and the palette coding unit 311 determine whether the coding mode is palette coding (step 902).

If the coding mode is palette coding (Yes in step 902), the palette coding unit 311 performs palette coding of the block to be coded (step 903). Next, the band offset calculation unit 802 and the edge offset calculation unit 803 of the SAO filter unit 706 calculate offset values by using the local decoded pixel values of escape coded pixels in the block to be coded (step 904).

Next, the pixel filter unit 804 selects a filter mode and applies SAO filter processing of the selected filter mode to the escape coded pixels in the block to be coded (step 905). Then, the entropy coding unit 707 performs entropy coding for the palette, the index of each pixel, quantization results of escape coded pixels of the block to be coded, and SAO parameters.

Otherwise, if the coding mode is not palette coding (No in step 902), the predictive coding unit 703 performs predictive coding of the block to be coded (step 908). Next, the deblocking filter unit 704 applies deblocking filter processing to a local decoded pixel value of each pixel in the block to be coded (step 909).

Next, the SAO filter unit 705 calculates offset values by using local decoded pixel values of all of the pixels in the block to be coded (step 910). Next, the SAO filter unit 705 selects a filter mode and applies SAO filter processing of the selected filter mode to all of the pixels in the block to be coded (step 911). Then, the entropy coding unit 707 performs entropy coding for predictive coding parameters, coefficient information, and SAO parameters.

Next, the video coding apparatus 301 checks whether all of the blocks in the image have been coded (step 906). If there remains a block that has not been coded (No in step 906), the video coding apparatus 301 repeats step 901 and the subsequent steps for the next block.

If all of the blocks are coded (Yes in step 906), the video coding apparatus 301 checks whether all of the images included in the video to be coded have been coded (step 907). If there remains an image that has not been coded (No in step 907), the video coding apparatus 301 repeats step 901 and the subsequent steps for the next image. Then, if all of the images have been coded (Yes in step 907), the video coding apparatus 301 terminates the process.

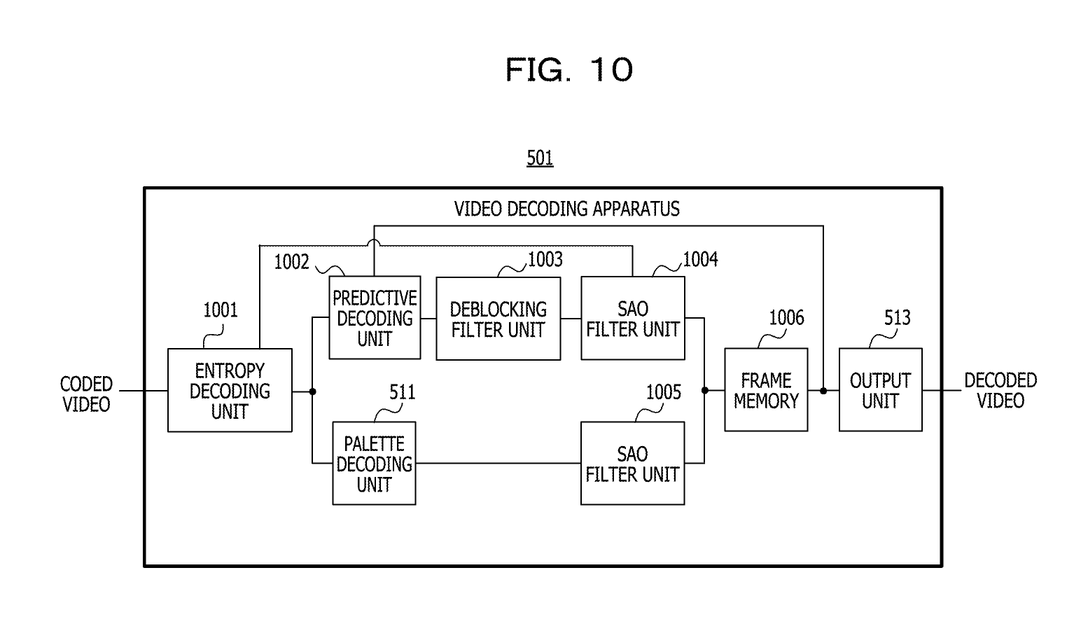

FIG. 10 illustrates a specific example of the video decoding apparatus 501 in FIG. 5. The video decoding apparatus 501 in FIG. 10 includes a palette decoding unit 511, an output unit 513, an entropy decoding unit 1001, a predictive decoding unit 1002, a deblocking filter unit 1003, an SAO filter unit 1004, an SAO filter unit 1005, and a frame memory 1006. The SAO filter unit 1005 corresponds to the filter unit 512 in FIG. 5.

The video decoding apparatus 501, for example, may be implemented as a hardware circuit. In this case, components of the video decoding apparatus 501 may be implemented as individual circuits, or may be implemented as one integrated circuit.

Bit streams of a coded video output from the video coding apparatus 301 in FIG. 7 are input as bit streams of a video to be decoded to the video decoding apparatus 501. The video decoding apparatus 501 decodes the bit streams of the coded video and outputs a decoded video.

The entropy decoding unit 1001 performs entropy decoding for the bit streams of a coded video and extracts image-by-image coding parameters, SAO parameters of each LCU in an image, and the coding mode of each block. The entropy decoding unit 1001 further extracts predictive coding parameters, coefficient information, palette coding parameters, a palette, indices, and quantization results of escape coded pixels.

The entropy decoding unit 1001 outputs the image-by-image coding parameters and the coding mode of each block to the predictive decoding unit 1002 and the palette decoding unit 511 and outputs the SAO parameters to the SAO filter unit 1004 and the SAO filter unit 1005. The entropy decoding unit 1001 outputs the predictive coding parameters and the coefficient information to the predictive decoding unit 1002 and outputs the palette coding parameters, the palette, the indices, and the quantization results of the escape coded pixels to the palette decoding unit 511.

The frame memory 1006 is a storage unit that stores therein a decoded image of each block and outputs a decoded image as a reference image for a block to be decoded to the prediction decoding unit 1002.

The predictive decoding unit 1002 performs predictive decoding of a block to be decoded when the coding mode is intra-predictive coding or inter-predictive coding. At this point, the predictive decoding unit 1002 inverse quantizes coefficient information and then inverse orthogonal transforms it to generate a reconfigured prediction error, and adds the reconfigured prediction error and a predictive pixel value together to generate a decoded pixel value before post-filtering. The predictive pixel value is generated from the decoded pixel value of the adjacent block or the decoded pixel value of a reference image. The predictive decoding unit 1002 then outputs the decoded pixel value before post-filtering to the deblocking filter unit 1003.

The deblocking filter unit 704 applies deblocking filter processing to the decoded image value before post-filtering and outputs a result of the deblocking filter processing to the SAO filter unit 1004.

When the filter mode of SAO parameters output from the entropy decoding unit 1001 is band offset or edge offset, the SAO filter unit 1004 applies SAO filter processing to the result of deblocking filter processing. The SAO filter unit 1004 adds the offset value in the filter mode of SAO parameters to the pixel value of each pixel in the block to generate a decoded pixel value after post-filtering, and outputs the decoded pixel value to the frame memory 1006.

The frame memory 1006 stores therein the decoded pixel value of each pixel in the block to be decoded, as a decoded image, and outputs the decoded pixel value to the output unit 513 in accordance with the displaying timing. The decoded image stored in the frame memory 1006 is used as a reference image for the subsequent images. The output unit 513 outputs decoded images of all of the blocks in an image at each time included in a coded video, as one screen of a decoded video, to a display device and the like, which are not illustrated.

When the coding mode is palette coding, the palette decoding unit 511 performs palette decoding of a block to be decoded to generate a decoded pixel value before post-filtering from the index of each pixel. The palette decoding unit 511 then outputs the index of each pixel in the block to be decoded and the decoded pixel value to the SAO filter unit 1005.

When a pixel value corresponding to an index is registered in a palette, the palette decoding unit 511 uses the pixel value as a decoded pixel value before post-filtering. In contrast, when the index indicates escape coding, the palette decoding unit 511 inverse quantizes a quantization result of an escape coded pixel to generate a decoded pixel value before post-filtering.

When the filter mode of SAO parameters output from the entropy decoding unit 1001 is band offset or edge offset, the SAO filter unit 1005 applies SAO filter processing to a decoded pixel value before post-filtering. At this point, the SAO filter unit 1005 adds an offset value in the filter mode of SAO parameters to the decoded pixel value of each escape coded pixel in the block to generate a decoded pixel value after post-filtering, and outputs the decoded pixel value to the frame memory 1006.

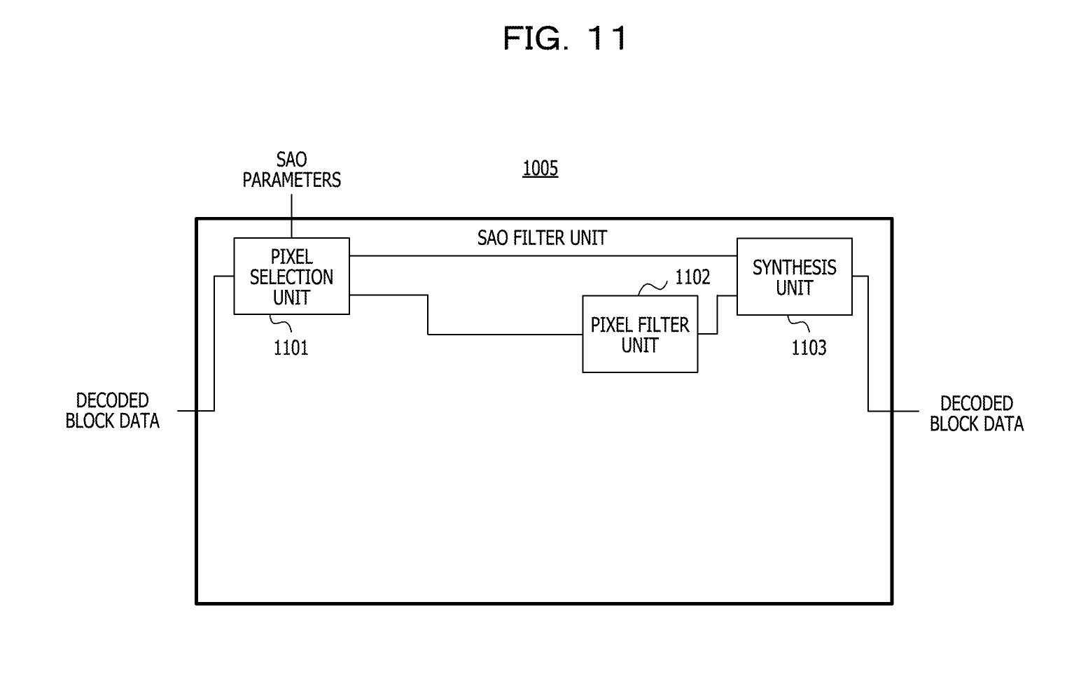

FIG. 11 illustrates an example of a functional configuration of the SAO filter unit 1005 in FIG. 10. The SAO filter unit 1005 in FIG. 11 includes a pixel selection unit 1101, a pixel filter unit 1102, and a synthesis unit 1103. Decoded block data, in which decoded pixel values of escape coded pixels and non-escape coded pixels exist in a mixed manner, and SAO parameters are input to the pixel selection unit 1101.

The pixel selection unit 1101 refers to the index of each pixel in a block and, if the index indicates an escape coded pixel, the pixel selection unit 1101 outputs the filter mode and a list of offset values of SAO parameters, and the decoded pixel value of the pixel to the pixel filter unit 1102. Otherwise, if the index indicates a non-escape coded pixel, the pixel selection unit 1101 outputs the decoded pixel value of the pixel to the synthesis unit 1103.

Based on the filter mode and using the list of offset values, the pixel filter unit 1102 adds the offset value of an escape coded pixel to the decoded pixel value of the escape coded pixel, and outputs the decoded pixel value, which is a result of the addition, to the synthesis unit 1103.

The synthesis unit 1103 outputs decoded pixel values output from the pixel selection unit 1101 for non-escape coded pixels in the block, and outputs decoded pixel values output from the pixel filter unit 1102 for escape coded pixels. Thus, decoded block data in which decoded pixel values to which filter processing is applied and decoded pixel values to which filter processing is not applied exist in a mixed manner is output.

According to the video decoding apparatus 501 in FIG. 10, SAO filter processing is applied only to escape coded pixels among pixels in a palette coded block, and SAO filter processing is not applied to non-escape coded pixels. Accordingly, the image quality of non-escape coded pixels where degradation due to quantization has not occurred is not impaired, and therefore a decoded image of high image quality may be generated. Furthermore, predictive decoding of the subsequent images is performed by using the decoded image of high image quality as a reference image, and thus a video of high image quality may be restored.

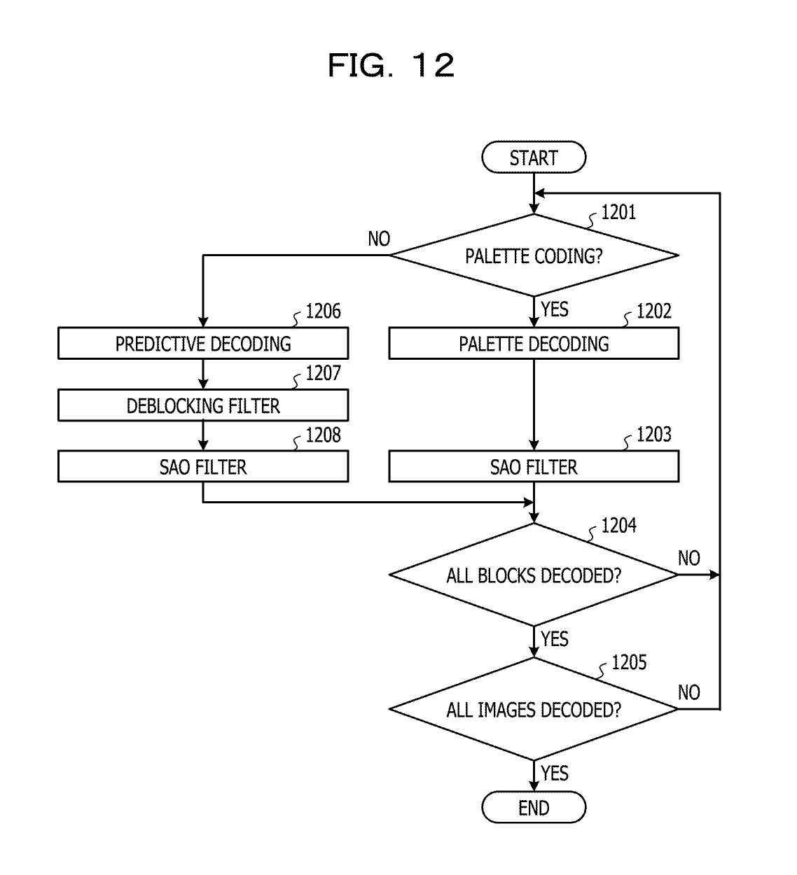

FIG. 12 is a flowchart illustrating a specific example of a video decoding process executed by the video decoding apparatus 501 in FIG. 10. First, the predictive decoding unit 1002 and the palette decoding unit 511 determine whether the predictive mode of a block to be decoded in an image included in a coded video is palette coding (step 1201).

If the coding mode is palette coding (Yes in step 1201), the palette decoding unit 511 performs palette decoding of the block to be decoded (step 1202). Next, the pixel filter unit 1102 of the SAO filter unit 1005 applies SAO filter processing indicated by the filter mode to escape coded pixels in the block to be decoded (step 1203). Then, the synthesis unit 1103 outputs a decoded image of the block to be decoded, which includes decoded pixel values to which the SAO filter processing has been applied and decoded pixel values of non-escape coded pixels.

Otherwise, if the coding mode is not palette coding (No in step 1201), the predictive decoding unit 1002 performs predictive decoding of the block to be decoded (step 1206). Next, the deblocking filter unit 1003 applies deblocking filter processing to the decoded pixel value of each pixel in the block to be decoded (step 1207). Next, the SAO filter unit 1004 applies the SAO filter processing indicated by the filter mode to all of the pixels in the block to be decoded, and outputs a decoded image of the block to be decoded (step 1208).

Next, the video decoding apparatus 501 checks whether all of the blocks in the image have been decoded (step 1204). If there remains a block that has not been decoded (No in step 1204), the video decoding apparatus 501 repeats step 1201 and the subsequent steps for the next block.

If all of the blocks have been decoded (Yes in step 1204), the video decoding apparatus 501 checks whether all of the images included in a coded video have been decoded (step 1205). If there remains an image that has not been decoded (No in step 1205), the video decoding apparatus 501 repeats step 1201 and the subsequent steps for the next image. If all of the images have been decoded (Yes in step 1205), the video decoding apparatus 501 terminates the process.

In the case of the HEVC standard, SAO parameters are transmitted from the video coding apparatus 301 to the video decoding apparatus 501 on a per-LCU (per-CTU) basis. However, a CU that has been palette coded and a CU that has not been palette coded differ in terms of pixels to be subjected to SAO filter processing, and therefore it is desirable in some cases that these CUs use SAO parameters different from each other. Accordingly, when a CU to be coded has been palette coded, it is conceivable to add SAO parameters to the syntax of the CU to be coded in addition to the syntax of the CTU.

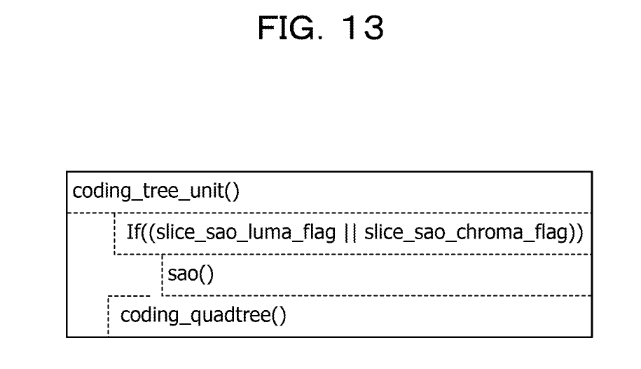

FIG. 13 illustrates an example of syntax of a CTU. The syntax in FIG. 13 is equivalent to the HEVC standard. If slice_sao_luma_flag or slice_sao_chroma_flag is a logical “1”, that is, if the SAO filter processing is enabled, a SAO parameter sao( ) is transmitted on a per-LCU basis.

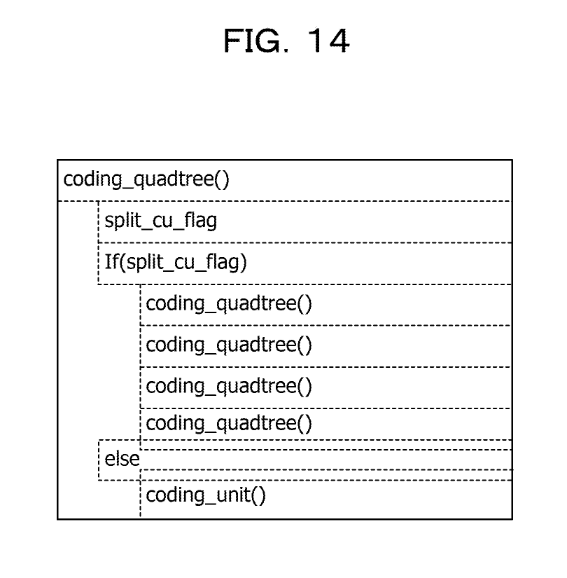

FIG. 14 illustrates an example of syntax of coding quadtree. The syntax in FIG. 14 is equivalent to the HEVC standard. If the coding quadtree flag split_cu_flag is a logical “0”, CU data coding_unit( ) emerges.

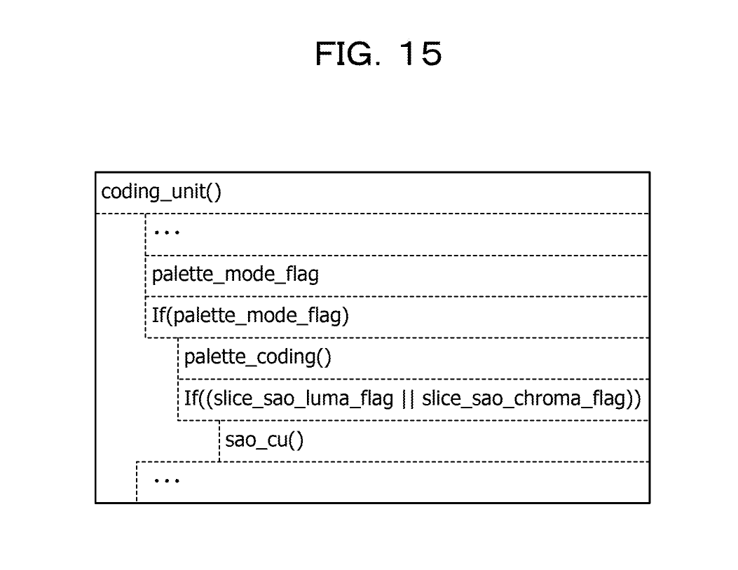

FIG. 15 illustrates an example of syntax of a CU. The syntax in FIG. 15 is equivalent to the HEVC standard, except for two rows following palette_coding( ). If slice_sao_luma_flag or slice_sao_chroma_flag is a logical “1”, that is, if SAO filter processing is enabled, a newly added SAO parameter sao_cu( ) is transmitted on a per-CU basis. The parameter sao_cu( ) is an SAO parameter applied only to the corresponding CU, and the SAO parameter sao( ) on a per-LCU basis is disabled for the CU. Using the syntax in FIG. 15 enables SAO parameters to be transmitted on a per-CU basis.

The video coding apparatus 301 and the video decoding apparatus 501 are used for various applications. For example, the video coding apparatus 301 and the video decoding apparatus 501 may be incorporated into a video transmitting apparatus, a video receiving apparatus, a video telephony system, a virtual desktop system, a computer, or a cellular phone.

The configurations of the video coding apparatus 301 in FIG. 3 and FIG. 7 are only exemplary, and some of the components may be omitted or changed in accordance with an application or conditions of the video coding apparatus 301. For example, in the video coding apparatus 301 in FIG. 7, when predictive coding of a block is not performed, the predictive coding unit 703, the deblocking filter unit 704, and the SAO filter unit 705 may be omitted. When entropy coding is not performed, the entropy coding unit 707 may be omitted.

The configuration of the video decoding apparatus 501 in FIG. 5 and FIG. 10 is only exemplary, and some of the components may be omitted or changed in accordance with an application or conditions of the video decoding apparatus 501. For example, in the video decoding apparatus 501 in FIG. 10, when predictive decoding of a block is not performed, the predictive decoding unit 1002, deblocking filter unit 1003, and the SAO filter unit 1004 may be omitted. When entropy decoding is not performed, the entropy decoding unit 1001 may be omitted.

The configuration of the SAO filter unit 706 in FIG. 8 is only exemplary, and some of the components may be omitted or changed in accordance with an application or conditions of the video coding apparatus 301. For example, the band offset calculation unit 802 may be omitted when the filter mode of band offset is not used, the edge offset calculation unit 803 may be omitted when the filter mode of edge offset is not used.

The configuration of the SAO filter unit 1005 in FIG. 11 is only exemplary, and some of the components may be omitted or changed in accordance with an application or conditions of the video decoding apparatus 501.

The flowcharts illustrated in FIG. 4, FIG. 6, FIG. 9, and FIG. 12 are only exemplary, and some of the processes may be omitted or changed in accordance with the configurations and conditions of the video coding apparatus 301 and the video decoding apparatus 501. For example, in the video coding process in FIG. 9, when predictive coding of a block is not performed, steps 908 to 911 may be omitted. In the video decoding process in FIG. 12, when predictive decoding of a block is not performed, steps 1206 to 1208 may be omitted.

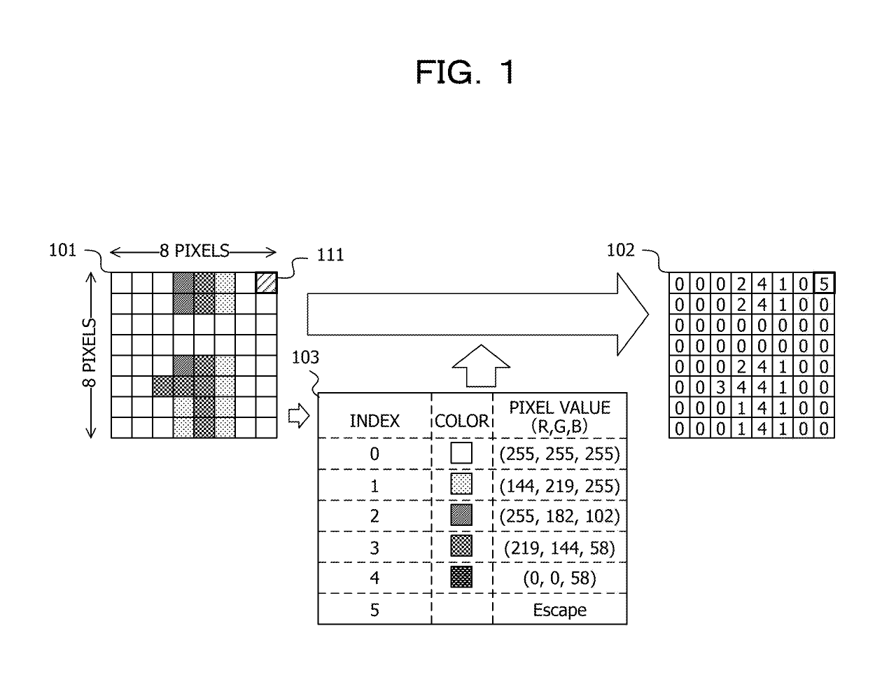

The palette coding in FIG. 1 and the filter processing in FIG. 2 are only exemplary, and the data structure of a palette, the edge direction and the category of edge offset, the range of band offset, and the like change in accordance with a video to be coded. The syntaxes in FIG. 13 to FIG. 15 are only exemplary, and other syntaxes may be used in accordance with a moving image coding standard.

A video to be coded to which palette coding is applied is not limited to a video including a screen content image and may be a video including another image with a small range of variations of pixel values.

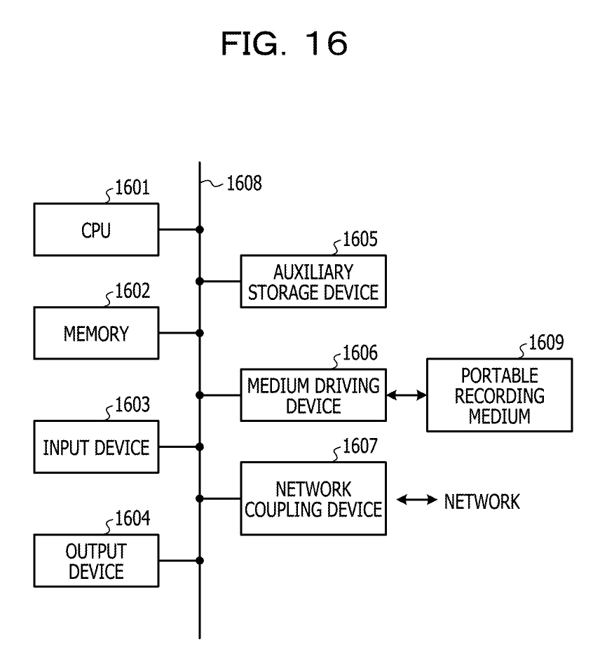

The video coding apparatus 301 in FIG. 3 and FIG. 7 and the video decoding apparatus 501 in FIG. 5 and FIG. 10 may also be implemented as hardware circuits and may also be implemented by using an information processing apparatus (computer) as illustrated in FIG. 16.

An information processing apparatus in FIG. 16 includes a central processing unit (CPU) 1601, a memory 1602, an input device 1603, an output device 1604, an auxiliary storage device 1605, a medium driving device 1606, and a network coupling device 1607. These components are coupled to each other by a bus 1608.

The memory 1602 is, for example, semiconductor memory such as read-only memory (ROM), random access memory (RAM), or flash memory and stores therein programs and data used for processing. The memory 1602 may be used as the frame memory 702 in FIG. 7 or the frame memory 1006 in FIG. 10.

The CPU 1601 (processor), for example, operates as the palette coding unit 311 in FIG. 3 and FIG. 7 and as the filter unit 312 in FIG. 3 by executing a program by using the memory 1602. The CPU 1601 also operates as the coding mode determination unit 701, the predictive coding unit 703, the deblocking filter unit 704, the SAO filter unit 705, the SAO filter unit 706, and the entropy coding unit 707 in FIG. 7 by executing a program.

The CPU 1601 also operates as the pixel selection unit 801, the band offset calculation unit 802, the edge offset calculation unit 803, the pixel filter unit 804, and the synthesis unit 805 in FIG. 8 by executing a program.

The CPU 1601 operates as the palette decoding unit 511 in FIG. 5 and FIG. 10 and the filter unit 512 in FIG. 5 by executing a program. The CPU 1601 also operates as the entropy decoding unit 1001, the predictive decoding unit 1002, the deblocking filter unit 1003, the SAO filter unit 1004, and the SAO filter unit 1005 in FIG. 10 by executing a program.

The CPU 1601 also operates as the pixel selection unit 1101, the pixel filter unit 1102, and the synthesis unit 1103 in FIG. 11 by executing a program.

The input device 1603 is, for example, a keyboard, a pointing device, or the like and is used for input of instructions and information from the user or operator. The output device 1604 is, for example, a display device, a printer, a speaker, or the like and is used for output of inquiries and processing results to the user or operator. The processing result may be a decoded video.

The auxiliary storage device 1605 is, for example, a magnetic disk device, an optical disk device, a magnet-optical disk device, a tape device, or the like. The auxiliary storage device 1605 may be a hard disk drive or flash memory. The information processing apparatus may store programs and data in the auxiliary storage device 1605, load them into the memory 1602, and use them.

The medium driving device 1606 drives a portable recording medium 1609 and accesses the recorded content. The portable recording medium 1609 is a memory device, a flexible disk, an optical disk, a magnet-optical disk, or the like. The portable recording medium 1609 may be compact disk read-only memory (CD-ROM), a digital versatile disk (DVD), or universal serial bus (USB) memory. The user or operator may store programs and data in the portable recording medium 1609, load them into the memory 1602, and use them.

In such a manner, examples of a computer-readable recording medium that stores therein programs and data used for processing include physical (non-temporary) recording media such as the memory 1602, the auxiliary storage device 1605, and the portable recording medium 1609.

The network coupling device 1607 is a communication interface that is coupled to a communication network such as a local area network (LAN) or the Internet and performs data conversion associated with communication. The network coupling device 1607 may be used as the output unit 313 in FIG. 3 and FIG. 7. The information processing apparatus may receive programs and data from an external device via the network coupling device 1607, load them into the memory 1602, and use them.

Note that the information processing apparatus does not have to include all of the components illustrated in FIG. 16, and part of the components may be omitted in accordance with an application or conditions. For example, when an interface with the user or operator is unnecessary, the input device 1603 and the output device 1604 may be omitted. In addition, when the information processing apparatus does not access the portable recording medium 1609, the medium drive device 1606 may be omitted.

Although the disclosed embodiment and advantages thereof have been described in detail, a person skilled in the art would be able to make various changes, additions, and omissions without departing from the scope of the present disclosure clearly described in claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An apparatus for video coding, the apparatus comprising:
a memory; and
a processor coupled to the memory and configured to
execute a palette coding process that includes
palette coding a first pixel value out of a plurality of pixel values in a block to be coded included in a video to be coded to generate a coding result of the first pixel value, the first pixel value being registered in a palette of the block to be coded,
quantizing a second pixel value out of the plurality of pixel values to generate a quantization result of the second pixel value, the second pixel value being not registered in the palette,
generating a first local decoding result from the coding result of the first pixel value, and
generating a second local decoding result from the quantization result of the second pixel value,
execute a local decoded image generation process that includes
applying filter processing to the second local decoding result to generate and store a local decoded image of the block to be coded into the memory in preparation for a predictive coding, the local decoded image including the first local decoding result and a result obtained by applying the filter processing to the second local decoding result,
execute an output process that includes
outputting a coded video including the coding result of the first pixel value and the quantization result of the second pixel value.

2. The apparatus according to claim 1,
wherein the memory is configured to store the local decoded image of the block to be coded,
wherein the processor is further configured to
execute a predictive coding process that includes performing predictive coding of a block included in the video to be coded, with reference to the local decoded image.

3. The apparatus according to claim 1,
wherein the filter processing includes first filter processing that corrects distortion of an edge in the block to be coded or second filter processing that corrects distortion of gray scale in the block to be coded.

4. A non-transitory computer-readable storage medium for storing a program that causes a processor to execute a process for video coding, the process comprising:
executing a palette coding process that includes
palette coding a first pixel value out of a plurality of pixel values in a block to be coded included in a video to be coded to generate a coding result of the first pixel value, the first pixel value being registered in a palette of the block to be coded,
quantizing a second pixel value out of the plurality of pixel values to generate a quantization result of the second pixel value, the second pixel value being not registered in the palette,
generating a first local decoding result from the coding result of the first pixel value, and
generating a second local decoding result from the quantization result of the second pixel value,
executing a local decoded image generation process that includes
applying filter processing to the second local decoding result to generate and store a local decoded image of the block to be coded into a memory in preparation for a predictive coding, the local decoded image including the first local decoding result and a result obtained by applying the filter processing to the second local decoding result,
executing an output process that includes
outputting a coded video including the coding result of the first pixel value and the quantization result of the second pixel value.

5. The non-transitory computer-readable storage medium according to claim 4,
wherein the process further includes
executing a predictive coding process that includes performing predictive coding of a block included in the video to be coded, with reference to the local decoded image stored in the memory.

6. A method performed by a computer for video coding, the method comprising:
executing, by a processor of the computer, a palette coding process that includes
palette coding a first pixel value out of a plurality of pixel values in a block to be coded included in a video to be coded to generate a coding result of the first pixel value, the first pixel value being registered in a palette of the block to be coded,
quantizing a second pixel value out of the plurality of pixel values to generate a quantization result of the second pixel value, the second pixel value being not registered in the palette,
generating a first local decoding result from the coding result of the first pixel value, and
generating a second local decoding result from the quantization result of the second pixel value,
executing, by the processor of the computer, a local decoded image generation process that includes
applying filter processing to the second local decoding result to generate and store a local decoded image of the block to be coded into a memory in preparation for a predictive coding, the local decoded image including the first local decoding result and a result obtained by applying the filter processing to the second local decoding result,
executing, by the processor of the computer, an output process that includes
outputting a coded video including the coding result of the first pixel value and the quantization result of the second pixel value.

7. The method according to claim 6, further comprising:
executing, by the processor of the computer, a predictive coding process that includes performing predictive coding of a block included in the video to be coded, with reference to the local decoded image stored in the memory.

8. An apparatus for video decoding, the apparatus comprising:
a memory; and
a processor coupled to the memory and configured to
execute a palette decoding process that includes
palette decoding a coding result of a first pixel in a block to be decoded included in a video to be decoded, by using a palette of the block to be decoded, to restore a first pixel value of the first pixel, and
inverse quantizing a quantization result of a second pixel in the block to be decoded to restore a second pixel value of the second pixel,
execute a decoded image generating process that includes applying filter processing to the second pixel value to generate a decoded image of the block to be decoded, the decoded image including the first pixel value and a result obtained by applying the filter processing to the second pixel value, and
execute an output process that includes outputting a decoded video including the decoded image of the block to be decoded.

9. The apparatus according to claim 8,
wherein the memory is configured to store the decoded image of the block to be decoded, and
wherein the processor is further configured to execute a video decoding process that includes performing predictive decoding of a block included in the video to be decoded, with reference to the decoded image.

10. The apparatus according to claim 8,
wherein the filter processing includes first filter processing for correcting distortion of an edge in the block to be decoded or second filter processing for correcting distortion of gray scale in the block to be decoded.

11. A non-transitory computer-readable storage medium for storing a program that causes a processor to execute a process for video decoding, the process comprising:
executing a palette decoding process that includes
palette decoding a coding result of a first pixel in a block to be decoded included in a video to be decoded, by using a palette of the block to be decoded, to restore a first pixel value of the first pixel, and
inverse quantizing a quantization result of a second pixel in the block to be decoded to restore a second pixel value of the second pixel,
executing a decoded image generating process that includes applying filter processing to the second pixel value to generate a decoded image of the block to be decoded, the decoded image including the first pixel value and a result obtained by applying the filter processing to the second pixel value, and
executing an output process that includes outputting a decoded video including the decoded image of the block to be decoded.

12. The non-transitory computer-readable storage medium according to claim 11,
wherein process further includes executing a video decoding process that includes performing predictive decoding of a block included in the video to be decoded, with reference to the decoded image stored in a memory.

13. A method performed by a computer for video decoding, the method comprising:
executing, by a processor of the computer, a palette decoding process that includes
palette decoding a coding result of a first pixel in a block to be decoded included in a video to be decoded, by using a palette of the block to be decoded, to restore a first pixel value of the first pixel, and
inverse quantizing a quantization result of a second pixel in the block to be decoded to restore a second pixel value of the second pixel,
executing, by the processor of the computer, a decoded image generating process that includes applying filter processing to the second pixel value to generate a decoded image of the block to be decoded, the decoded image including the first pixel value and a result obtained by applying the filter processing to the second pixel value, and
executing, be the processor of the computer, an output process that includes outputting a decoded video including the decoded image of the block to be decoded.

14. The method according to claim 13, further comprising:
executing a video decoding process that includes performing predictive decoding of a block included in the video to be decoded, with reference to the decoded image stored in a memory.
